(19) United States
(12) Patent Application Publication
(10) Pub. No.: US 2008/0310762 A1
(43) Pub. Date: Dec. 18, 2008

(54) SYSTEM AND METHOD FOR GENERATING AND REGENERATING 3D IMAGE FILES BASED ON 2D IMAGE MEDIA STANDARDS

(75) Inventors: Gun-Ill LEE, Seoul (KR); Kwang-Cheol CHOI, Hwancheon-si (KR); Jae-Yeon SONG, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwom-si (KR)

(21) Appl. No.: 12/136,390

(22) Filed: Jun. 10, 2008

(30) Foreign Application Priority Data
Jun. 12, 2007 (KR) 57499-2007

(51) Int. Cl. G06K 9/54

(52) U.S. Cl. 382/305

(57) ABSTRACT

Disclosed are a system and a method for generating and regenerating three-dimensional (3D) image files based on two-dimensional (2D) image media standards. The system includes a 3D image file generating device for generating a 3D image file including a data area, which includes a first image data and a second image data, the second image data being synchronized with the first image data so as to be used for generating a 3D image and undergoing a data conversion process based on the first image data, a header area including information of the first image data, and a metadata area including information of the second image data, and a 3D image file regenerating device, which parses information of the first and second image data when a 3D image file is inputted so as to extract the first and second image data, restores the second image data through a data conversion process, and synthesizes the first image data and the restored second image data so as to regenerate the 3D image file.

### PRIORITY

This application claims priority to an application entitled “System and Method For Generating and Regenerating 3D Image Files Based on 2D Image Media Standards” filed in the Korean Industrial Property Office on Jun. 12, 2007 and assigned Serial No. 2007-57499, the contents of which are incorporated herein by reference.

### BACKGROUND OF THE INVENTION

1. Field of the Invention

The present invention relates to a system and a method for generating and regenerating a three dimensional (3D) image file based on two dimensional (2D) image media standards.

2. Description of the Related Art

Standardization of iMPEG-2, MPEG-4, MPEG-7, and MPEG-21 is in progress based on the Moving Picture Experts Group (MPEG), which is an international standardization organization regarding multimedia. As various standards have been developed, there has been a growing need for establishing one profile by combining different standard technologies. An example of an activity that has responded to this need is the MPEG-Application (MPEG-A: ISO/ICE 230000) multimedia application standardization.

Various Multimedia Application Formats (MAFs) have been developed as activities of the MPEG-A, in order to combine non-MPEG standards with typical MPEG standards so that the value of activity of a standard is higher. As such, without an effort to establish new separate standards, it is possible to establish a multimedia application format in such a manner that standard technologies, which have been previously verified, are combined with each other, and the effective value of the multimedia application format can be maximized. Currently, standardization of technologies such as Digital Audio Broadcasting MAF (DAB MAF) and Digital Multimedia Broadcasting MAF (DMB MAF) is in progress. However, standardization regarding a file format for storing 3D images is not in progress.

The latest image technology for implementing 3D images includes a technology for regenerating 3D images in only a portable terminal having a barrier Liquid Crystal Display (LCD) mounted therein. However, there are no known technologies for generating 3D images in typical portable terminals or a 3D image storing format for regeneration of 3D images.

### SUMMARY OF THE INVENTION

Accordingly, the present invention has been made to solve the above-mentioned problems occurring in the prior art, and provides a system and a method for regenerating a 3D image in a typical portable terminal. The present invention provides a three-dimensional file format for generating and regenerating a 3D image.

Also, the present invention provides a three-dimensional file format formed in such a manner that a part of a 2D image file format prescribed in International Standardization Organization (ISO) 14496-12 is changed according to a standardization activity regarding the multimedia application format of MPEG-A, wherein all generation and regeneration of 2D and 3D image files can be achieved by such a 3D file format.

Particularly, the present invention provides a 3D image file format for converting image data, which is newly added to a 2D image file, to various forms and storing the data.

The present invention further provides a system and method for generating and regenerating such a 3D image file.

In accordance with the present invention, there is provided a system for generating and regenerating a 3D image file base on 2D image media standards, the system including a 3D image file generating device for generating a 3D image file that includes a data area having first and second image data, the second image data being synchronized with the first image data so as to be used for generating a 3D image and undergoing a data conversion process based on the first image data, a header area including information of the first image data, a metadata area including information of the second image data; and a 3D image file regenerating device, which parses information of the first and the second image data when a 3D image file is inputted so as to extract the first image data and the second image data, restores the second image data through a data conversion process, and synthesizes the first image data and the restored second image data so as to regenerate the 3D image file.

In accordance with the present invention, there is provided a system for generating and regenerating a 3D image file based on 2D media standards, in which a 3D image file is generated and regenerated according to a 3D image file format constituted of a media data box (Mdat) area and a Moov box (Moov) area of a 2D image file format according to ISO 14496-12, and a metadata area including information regarding image data used for generating a three-dimensional image.

In accordance with the present invention, there is provided a method for generating and regenerating a 3D image file, based on 2D image media standards, the method including photographing an image of a lift sight point respective to a subject so as to output first image data, and photographing an image of a right sight point respective to the subject so as to output second image data, performing a pre-process on the first and second image data, storing the pre-processed first and second image data, encoding the stored first and second image data, performing a data conversion process on the encoded second image data based on the encoded first image data, and generating a three-dimensional image file constituted of a data area including the first and second image data, a header area including information of the first image data, and a metadata area including information of the second image data.

### BRIEF DESCRIPTION OF THE DRAWINGS

The above and other aspects, features and advantages of the present invention will be more apparent from the following detailed description taken in conjunction with the accompanying drawings, in which:

FIG. 1 illustrates a conventional 2D image file storing format;

FIG. 2A illustrates a first 3D image file storing format according to the present invention;

FIG. 2B illustrates a second 3D image file storing format according to the present invention;

FIG. 2C illustrates a third 3D image file storing format according to the present invention;

FIG. 3A illustrates a first 3D image file generating device according to the present invention;

FIG. 3B illustrates a first 3D image file regenerating device according to the present invention;

FIG. 4A illustrates a second 3D image file generating device according to the present invention;

FIG. 4B illustrates a second 3D image file regenerating device according to the present invention;

FIG. 5A illustrates a third 3D image file generating device according to the present invention;

FIG. 5B illustrates a third 3D image file regenerating device according to the present invention;

FIG. 6A illustrates a fourth 3D image file generating device according to the present invention;

FIG. 6B illustrates a fourth 3D image file regenerating device according to the present invention;

FIG. 7A illustrates a method for generating a 3D image file according to the present invention; and

FIG. 7B illustrates a method for regenerating a 3D image file according to the present invention.

### DETAILED DESCRIPTION OF THE PREFERRED EMBODIMENTS

Hereinafter, preferred embodiments of the present invention will be described with reference to the accompanying drawings. In the following description, the same elements will be designated by the same reference numerals although they are shown in different drawings. Further, a detailed description of known functions and configurations incorporated herein will be omitted for the sake of clarity and conciseness.

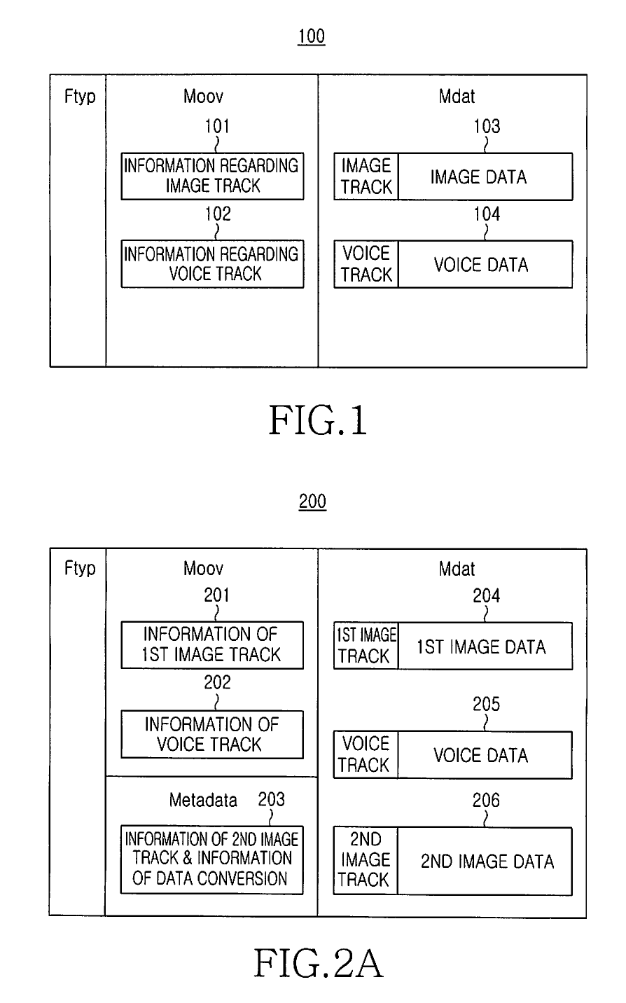

FIG. 1 illustrates a 2D image file storing format according to the conventional ISO 14496-12. The 2D image file storing format 100 includes a Moov area and an Mdat area. Herein, the Mdat area is a data area of the file format. The image track 103 includes actual image data, and a voice track 104 includes voice data. The image data and the voice data are stored in each track with a frame unit.

The Moov area corresponds to a header area of the file format and has a structure based on an object. The Moov area includes all pieces of information for regenerating files regarding contents information including a frame rate, a bit rate, the size of an image, and synchronization information for supporting a function for regenerating commands such as fast forward (FF) and rewind (REW). Particularly, image track information 101 or voice track information 102 includes information regarding the number of entire frames of image data or voice data and the size of each frame, so that image data and voice data can be reconstructed and regenerated in such a manner that the move area is parsed.

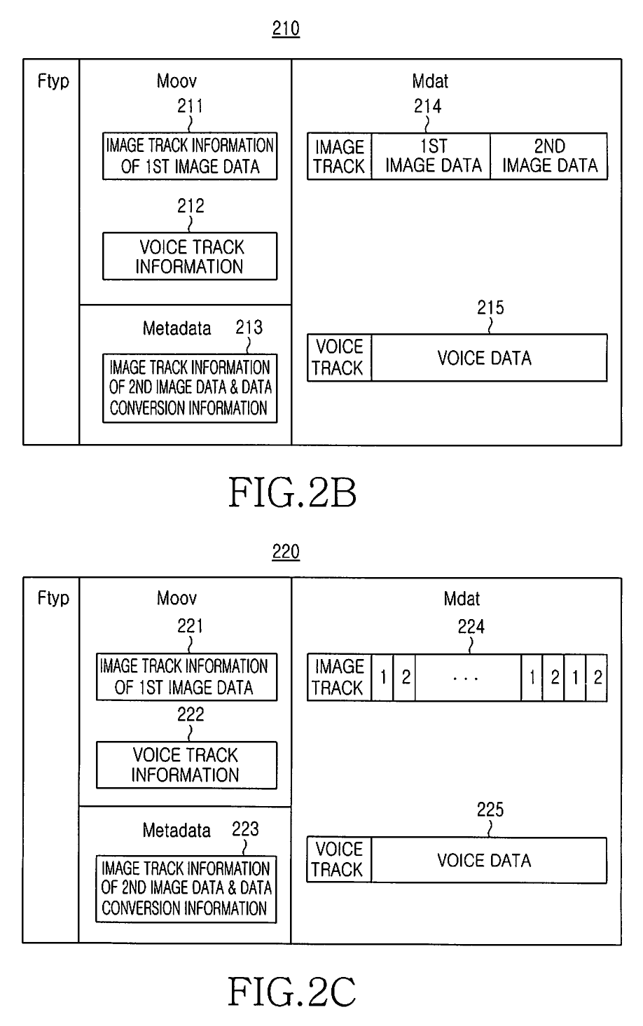

FIG. 2A illustrates a first 3D image file storing format according to the present invention. A 2D image file storing format 200 is formed in such a manner that only a metadata area is added to the 2D image file format shown in FIG. 1. Therefore, a structure and a function of the 2D image file format can be used without substantial alteration thereto. The Mdat area as a data area includes a voice track 205, a first image track 204 and a second image track 206. The first image track 204 includes first image data, and the second image track 206 includes second image data.

Herein, the first and second image data are formed by using a characteristic of the sense of sight of a human being, and are image data formed by photographing an image of the left sight point and an image of the right sight point by using the first camera and the second camera respective to a predetermined subject. As such, each separate image is generated and regenerated at the left and right eyes of the user so that the user feels a cubic effect. If one of the first and the second image data is regenerated, the user enjoys a 2D image, and if the first image data and the second image data are combined with each other to be regenerated, the user can enjoy a 3D image.

The Moov area as a header area includes information 201 regarding the first image track and information 202 regarding the voice track, and the metadata area includes information 203 regarding the second image track. Such track information includes, for example, information regarding the number of entire frames of each piece of image data or each piece of voice data, and the sizes of the frames, so that when a three-dimensional image is regenerated, each piece of data can be combined in such a manner that the information is analyzed.

The 3D image file storing format 200 further includes data conversion information 203, which relates to a method for performing a data converting process on the second image data constructed differently from a format of a conventional 2D image data in various manners so as to store it. Therefore, the data conversion information 203 is used for restoring the second image data when the three-dimensional file is regenerated. Due to such a data converting process, the amount of data of a 3D image file when a three-dimensional image file is transmitted can be reduced. The data converting process will be described below when a three-dimensional image file generating device is discussed.

FIG. 2B illustrates a second 3D image file storing format according to the present invention. The 3D image file storing format 210 includes an Mdat area as a data area, a Moov area as a header area, and a metadata area. However, in comparison with the first 3D image file storing format 200, there is one image track 214 instead of two image tracks, and the first and second image data are included in the one image track.

According to a storing method of 3D image file storing format 210, one of the first and the second image data is first stored, and then the remaining image data is stored. Therefore, it is possible to construct image data in only one track. The Moov area has the number of entire frames of the first image data, the sizes of the frames, and image track information 211 of the first image data such as information regarding a starting address of the image track, at which the first image data has been stored. The metadata area has the number of entire frames of the second image data, the sizes of the frames, and image track information 213 of the second image data regarding a starting address at which the second image data has been stored. As such, it is possible to synthesize and regenerate the first and the second image data into a 3D image.

Herein, similar to the 3D image file storing format 200, in the 3D image file storing format 210, it is possible to perform a data converting process on the second image data in various manners and store it into the image track 214. In addition, the data conversion information 213 includes information regarding such a data converting method, and it is possible to restore the second image data when a three-dimensional image is regenerated by using the data conversion information 213. Such a data converting process also can reduce the amount of 3D image file data, which will be described below in detail.

FIG. 2C illustrates a third 3D image file storing format according to the present invention. The 3D image file storing format 220 also includes an Mdat area as a data area, a Moov area as a header area, and a metadata area. However, although the 3D image file storing format 220 also includes one image track 224, similar to the 3D image file storing format 210, the first and the second image data are alternatively stored in the one image track in comparison with the 3D image file storing format 210. Therefore, the Moov area as the header area includes the number of entire frames of the first image data, the sizes of the frames, and image track information 221 of the first image data, such as offset information until the next first image data is arranged after a first image data, as well as information regarding a starting address of the image track, at which the first image data has been stored.

The metadata area also includes the number of entire frames of the second image data, the sizes of the frames, and image track information 223 of the second image data, such as offset information until the next second image data is arranged after a second image data, as well as information regarding a starting address of the image track, at which the second image data has been stored. Herein, the 3D image file storing format 220 can perform a data converting process on the second image data, which is added, in various manners and store them.

In addition, the 3D image file storing format 220 includes the image track information 223 required for restoring the second image data, which has undergone the data converting process. In such a data converting process, the amount of data of a 3D image file can be reduced when it is transmitted. The data converting process will be described below in the description of a three-dimensional image file generating device.

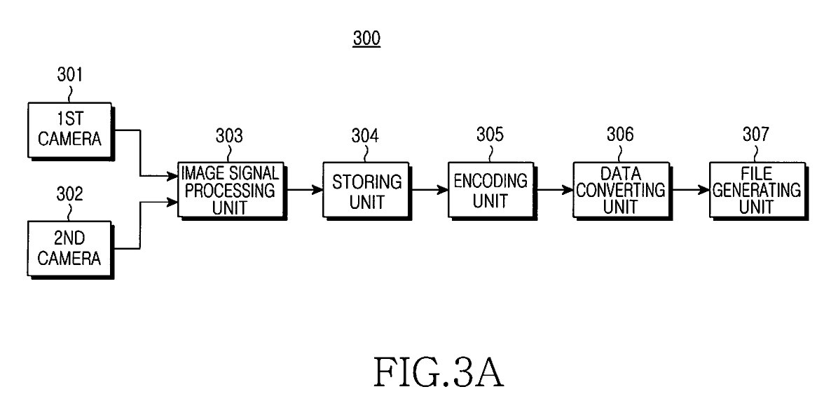

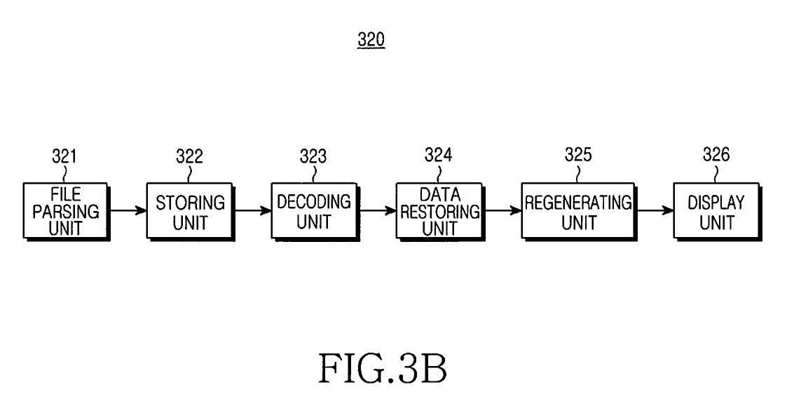

FIG. 3A illustrates a first 3D image file generating device according to the present invention. In FIG. 3, the 3D image file generating unit 300 includes a first camera 301, a second camera 302, an image signal processing unit 303, a storing unit 304, an encoding unit 305, a data converting unit 306 and a file generating unit 307.

The first camera 301 photographs an image of a left sight point or an image of a right sight point respective to a subject so as to output first image data. The second camera 302 photographs an image of another sight point, which is different from the sight point of the first camera 301, respective to the subject, so as to output second image data. The first and the second image data, which are output from the first camera 301 and the second camera 302, respectively, undergo pre-processing through the image signal processing unit 303. Herein, a pre-process operation is to convert an analogue value of an outer image value, i.e. elements of light and colors, which has recognized through a sensor in a Charge Coupled Device (CCD) type or a Complementary Metal-Oxide Semiconductor (CMOS) type, to a digital value.

The storing unit 304 stores the first and the second image data, which have undergone a pre-process through the image signal processing unit 303. Also, the encoding unit 305 encodes the stored first image data and the stored second image data. The encoding operation of the encoding unit 305 relates to data compression, and can be omitted if needed.

The data converting unit 306 has a structure for performing a data conversion process on the second image data so that the data converting unit 306 can perform a data conversion process in various manners. Such data converting unit 306 can be omitted. However, when a data convention process is performed on the second image data, a structure for restoring data conversion is required when a three-dimensional file is regenerated.

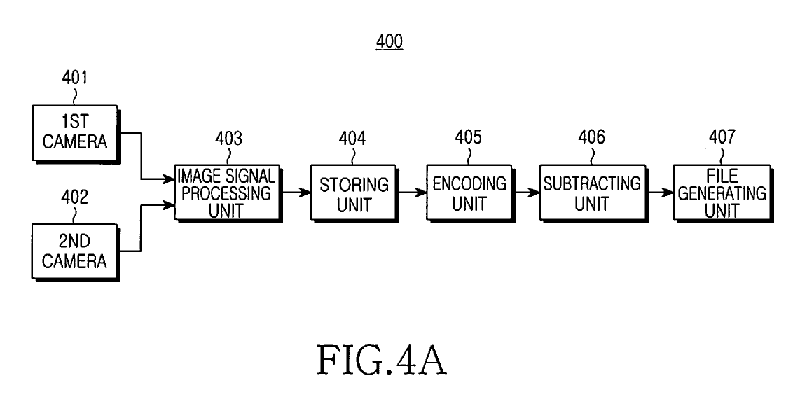

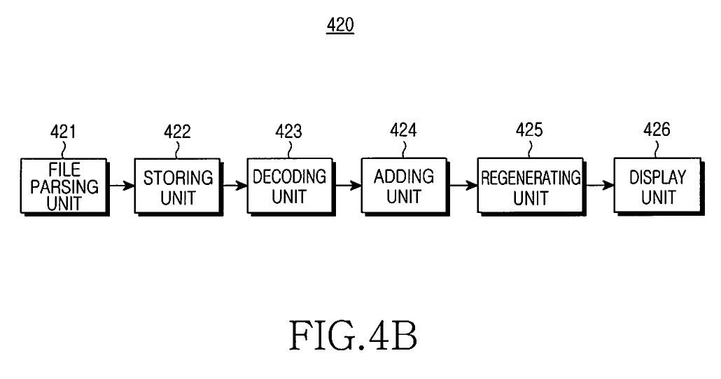

As an example of data conversion, there is a scheme for obtaining a difference between corresponding pixel values of the first and the second image data and stores it in a data area, in which the second image data will be stored, a scheme for reducing the size of the second image data with a ratio and storing it in a data area, in which the second image data will be stored, and a scheme for obtaining a distance between the first image data and the first camera 301 and a distance between the second image data and the second camera 302 and storing a difference between the distances as a data conversion value in a data area, in which the second image data will be stored. Each scheme will be described with reference to FIGS. 4a to 6b.

The file generating unit 307 generates a three-dimensional file by using the first image data encoded in the encoding unit 305 and the second image data, which has been encoded and has undergone a data conversion process. At this time, the first and the second image data are stored in the data area, track information of the first image data is stored in the header area, and track information of the second image data and information regarding a data conversion method of the second image data is stored in the metadata area. This information is utilized as useful information when a three-dimensional file is regenerated.

FIG. 3B illustrates a first 3D image file regenerating device according to the present invention. With reference to FIG. 3b, the 3D image file regenerating unit 320 includes a file parsing unit 321, a storing unit 322, a decoding unit 323, a data restoring unit 324, a regenerating unit 325 and a display unit 326.

The file parsing unit 321 receives a three-dimensional image file generated in the file generating unit 307 of the 3D image file generating device 320 so as to use it in parsing the 3D image file. At this time, the track information of the first image data and the track information of the second image data, which are stored in the header area and the metadata area, respectively, are parsed so that the stored first and the second image data are extracted and stored in the storing unit 322. The decoding unit 323 decodes the first and the second image data. This operation is performed when they have been encoded through the encoding unit 305 in the 3D image file generating unit 320.

Meanwhile, the data restoring unit 324 is a corresponding structure when the data converting unit 306 is used in the 3D image file generating unit 320 and is added to the 3D image file regenerating unit 320. The data restoring unit 324 finds a data converting scheme performed on the second image data, based on data conversion information stored in the metadata area of a three-dimensional file at the file encoding unit 305, and restores the second image data in a reverse manner. The regenerating unit 325 synthesizes the first image data, which has been decoded, and the second image data, which has been restored after decoding, into a three-dimensional image so as to regenerate them. At this time, track information stored in the header area and the metadata area of the 3D image file is used for the synthesis

Herein, when the regenerating unit 325 does not refer to the track information of the second image data, which is stored in the metadata area, only first image data is regenerated so that a typical 2D image is regenerated. Also, although a typical regenerating device, which can not regenerate a 3D image, receives a 3D image file, it is enough to refer only a Moov area according to a conventional standard, and not the metadata area, so that it is possible to regenerate a 2D image. As such, the 3D image file storing format according to the present invention has compatibility respective to regeneration of a conventional 2D image and a 3D image. The display unit 326 displays a three-dimensional image, which is synthesized and regenerated in the regenerating unit 325.

With reference to FIGS. 4A to 6B, various embodiments of the data converting unit 306 and the data restoring unit 324, which are mentioned in FIGS. 3A and 3B, will be described below.

With reference to FIG. 4A, a 3D file generating unit 400 includes a first camera 401, a second camera 402, an image signal processing unit 403, a storing unit 404, an encoding unit 405, a subtracting unit 406, and a file generating unit 407. Herein, the 3D file generating unit 400 employs a subtracting unit 406 as an example of the data converting unit 306 and descriptions of the remaining unites are equal to descriptions of those of the 3D image file generating unit 320 in FIG. 3A. Therefore, the descriptions are omitted for the sake of conciseness.

The subtracting unit 406 outputs a value obtained by subtracting each pixel of the second image data from each pixel value of the first image data. The value is set as a conversion value of the second image data and is stored in a data area in which the second image data will be stored. The subtracting unit 406 corresponds to an adding unit 424 of the 3D file regenerating device 420.

With reference to FIG. 4B, the 3D file regenerating device 420 includes a file parsing unit 421, a storing unit 422, a decoding unit 423, an adding unit 424, a regenerating unit 425 and a display unit 426. Herein, the 3D file regenerating device 420 employs the adding unit 424 as an example of the data restoring unit 324, and descriptions of the remaining units are of the same as those of the 3D image file generating unit 320 in FIG. 3B. As such, the descriptions are omitted here for the sake of conciseness.

The adding unit 424 is used for restoring the second image data converted by the subtracting unit 406 to an original value. The adding unit 424 can add the value obtained by the subtracting unit 406 and the first image data to each other so as to restore the second image data as an original value.

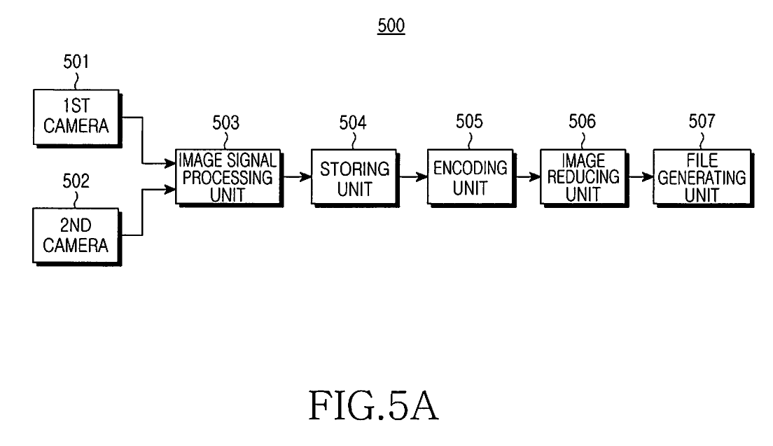

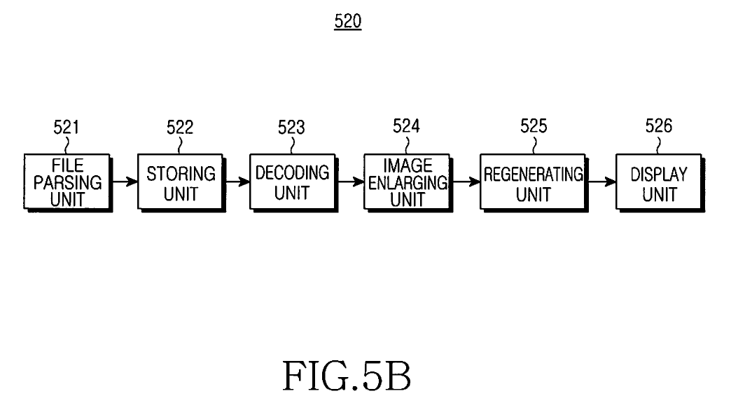

With reference to FIG. 5A, the 3D file generating device 500 includes a first camera 501, a second camera 502, an image signal processing unit 503, a storing unit 504, an encoding unit 505, an image reducing unit 506 and a file generating unit 507. Herein, the 3D file generating device 500 employs the image reducing unit 506 as an example of the data converting unit 306, and descriptions of the remaining units are of the same as those of the 3D image file generating unit 320 in FIG. 3a. As such, the descriptions are omitted here for the sake of conciseness. The image reducing unit 506 reduces the amount of a pixel value with a ratio of ½ or ¼, for example. The image reducing unit 506 corresponds to the image enlarging unit 524 of the 3D file regenerating device 520 shown in FIG. 5B.

With reference to FIG. 5B, the 3D file regenerating device 520 includes a file parsing unit 521, a storing unit 522, a decoding unit 523, an image enlarging unit 524, a regenerating unit 525 and a display unit 526. Herein, the 3D file regenerating device 520 employs the image enlarging unit 524 as an example of the data restoring unit 324, and descriptions of the remaining units are the same as those of the 3D image file generating unit 320 in FIG. 3b. As such, the descriptions are omitted here for the sake of conciseness. The image enlarging unit 524 restores the second image data reduced by the image reducing unit 506 in such a manner that the second image data is enlarged to be original one.

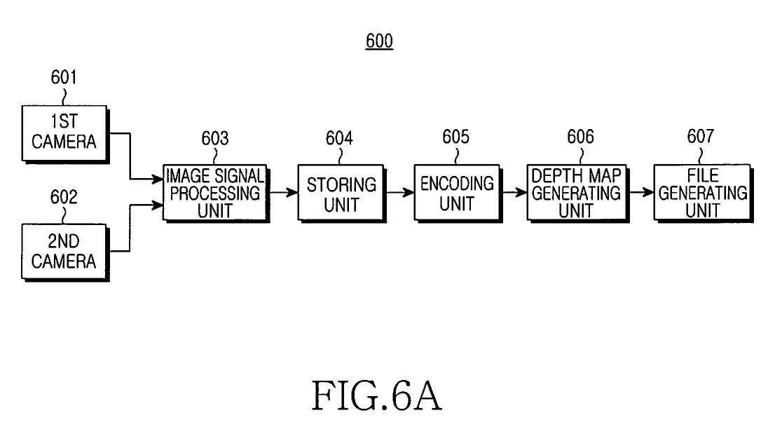

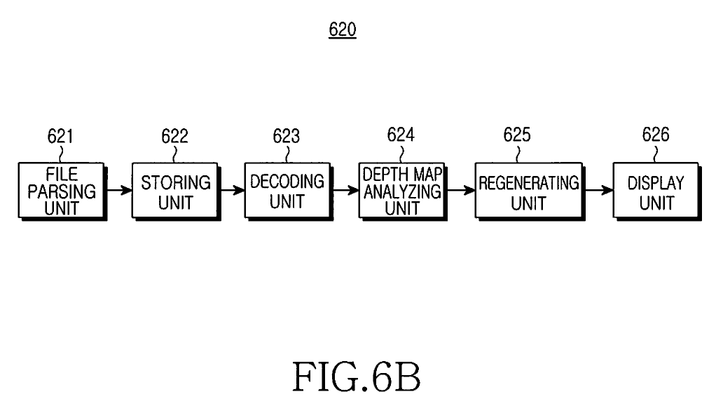

With reference to FIG. 6A, the 3D file generating device 600 includes a first camera 601, a second camera 602, an image signal processing unit 603, a storing unit 604, an encoding unit 605, a depth map generating unit 606 and a file generating unit 607. Herein, the 3D file regenerating device 520 employs the image enlarging unit 524 as an example of the data restoring unit 324, and descriptions of the remaining unites are of the same as those of the 3D image file generating unit 320 in FIG. 3B. As such, the descriptions are omitted here for the sake of conciseness. The depth map generating unit 606 generates a depth map showing a distance between each pixel value of the first image data and the first camera 601 and a distance between each pixel value of the second image data and the second camera 602 as a numerical value. Such depth map information can be stored in the data area as a conversion value of the second image data. The depth map generating unit 606 corresponds to a depth map analyzing unit 624 of a 3D image file generating device 620.

With reference to FIG. 6B, the 3D image file generating device 620 includes a file parsing unit 621, a storing unit 622, a decoding unit 623, a depth map analyzing unit 624, a regenerating unit 625 and a display unit 626. Herein, the depth map analyzing unit 624 is employed as an example of the data restoring unit 324, and descriptions of the remaining units are the same as those of the 3D image file generating unit 320 in FIG. 3B. As such, the descriptions are omitted here for the sake of conciseness. The depth map analyzing unit 624 restores an algorithm used in the depth map generating unit 606 in a reverse manner.

Next, a method for generating and regenerating a 3D image file by using 3D image file formats 200, 210, and 220 will be described.

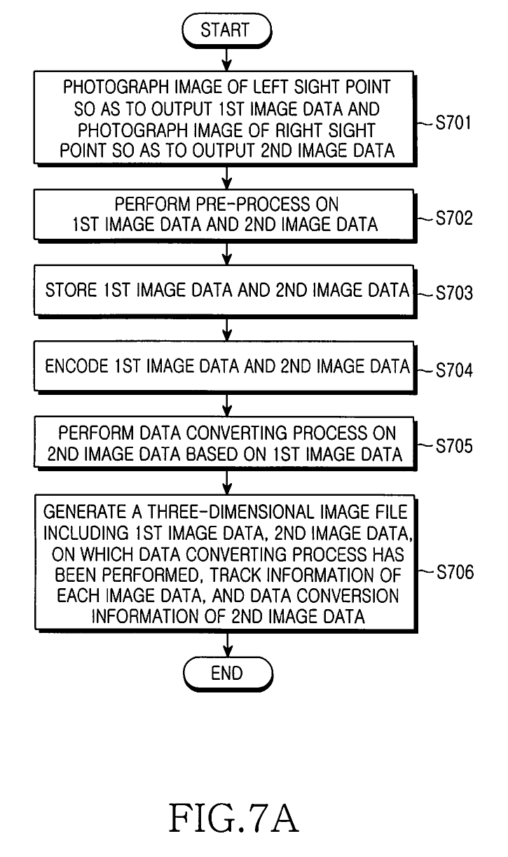

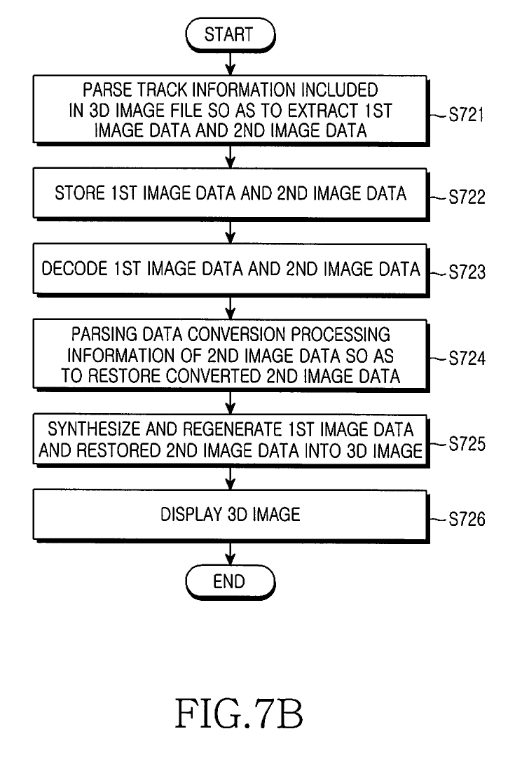

FIG. 7a illustrates a method for generating a 3D image file according to one embodiment of the present invention. With reference to FIG. 7A, the 3D image file generating method includes a photographing step S701, a pre-processing step S702, a storing step S703, and an encoding step S704, a data converting step S705 and a file generating step S706. In the photographing step S701, a subject is photographed at a left sight point or a right sight point by using a first camera or a second camera. In the pre-processing step S702, pre-processing is performed on the first image data and the second image data, which are outputted in the photographing step S701, and an analogue value obtained through an image sensor is converted to a digital value.

The first and the second image data, which have undergone the pre-process, are stored in the storing step S703. The first and the second image data are encoded in the encoding step S704. The encoding step S704 can be omitted. The data converting step S705 is for performing a data conversion on the second image data for a three-dimensional image. The second image data is converted by subtracting the second image data from the first image data, reducing the second image data, or generating a depth map. The file generating step S706 is for generating a three-dimensional image file by using the first and the second image data undergoing the data conversion process. The three-dimensional file can use a format mentioned in FIGS. 2A to 2C.

FIG. 7B illustrates a method for regenerating a 3D image file according to the present invention. In FIG. 7B, a 3D image file regenerating method includes an image extracting step S721, a storing step S722, a decoding step S723, a data restoring step S724, a regenerating step S725 and a displaying step S726. The image extracting step S 721 is for parsing a 3D image file generated in the file generating step S706 and extracting the first image data and the second image data. The extracted first and the second image data are stored in the storing step S722. The decoding step S723 is performed only when the first and the second image data have been encoded in the encoding step S704, and is a step for decoding them into an identical algorithm.

The data restoring step S724 corresponds to the data converting step S705, and is added only when image data has undergone the data converting step S705. While corresponding to a data conversion process performed in the data converting step S705, the second image data is restored in the data restoring step S724. The regenerating step S725 utilizes track information regarding the first image data, which has been decoded, and the second image data, which has been restored after decoding so as to synthesize each pixel, thereby regenerating a 3D image. The display step S726 is for displaying a regenerated 3D image.

As described above, according to the present invention, a verification process as a new standard can be simplified by using a standard technique, which has been already verified, in a regulation of a 3D image file format. There is also an advantage in that one of a 2D image file or a 3D image file is selected so as to be generated or regenerated by a new 3D image file format.

Particularly, newly added image data is converted into various types and is stored in the 3D image file format so that the amount of image data, which is stored and transmitted, can be minimized.

What is claimed is:

1. A system for generating and regenerating a three-dimensional (3D) image file based on two-dimensional (2D) image media standards, the system comprising:
a 3D image file generating device for generating a 3D image file, the 3D image file including a data area having a first image data and a second image data, the second image data being synchronized with the first image data so as to be used for generating a 3D image and undergoing a data conversion process based on the first image data, a header area including information of the first image data, and a metadata area including information of the second image data; and
a 3D image file regenerating device, which parses information of the first image data and information of the second image data when a 3D image file is inputted so as to extract the first image data and the second image data, restores the second image data through a data conversion process, and synthesizes the first image data and the restored second image data so as to regenerate the 3D image file.

2. The system claimed in claim 1, wherein the 3D image file regenerating device extracts the first image data in such a manner that information of the second image data is not parsed, but only information of the first image data is parsed so that the 3D image file regenerating device regenerates a 2D image.

3. The system as claimed in claim 1, wherein the information of the first image data includes information regarding a track within the data area of the first image data.

4. The system as claimed in claim 1, wherein the information of the second image data includes information regarding a track within the data area of the second image data and information regarding the data conversion.

5. The system as claimed in claim 3, wherein the 3D image file regenerating device extracts the first image data by using the information regarding the track within the data area of the first image data.

6. The system as claimed in claim 4, wherein the 3D image file regenerating device extracts the second image data by using the information regarding the track within the data area of the second image data and restores the second image data by using the information regarding the data conversion.

7. The system as claimed in claim 1, wherein the 3D image file generating device further comprises:
a first camera for photographing an image of a left sight point respective to a subject so as to output the first image data;
a second camera for photographing an image of a right sight point respective to the subject so as to output the second image data;
an image signal processing unit for performing a pre-process on the first image data and the second image data which are outputted by the first camera and the second camera, respectively;
a storing unit for storing the first image data and the second image data which have undergone the pre-process;
an encoding unit for encoding the stored first image data and the stored second image data;
a data converting unit for performing a data conversion on the encoded second image data based on the encoded first image data; and
a generating unit for generating the 3D image file by using the first image data and the second image data that have undergone the data conversion process.

8. The system as claimed in claim 1, wherein the 3D image file regenerating device comprises:
a file parsing unit for parsing information of the first image data and information of the second image data so as to extract the first image data and the second image data;
a storing unit for storing the extracted first image data and the extracted second image data;
a decoding unit for decoding the stored first image data and stored second image data;
a data restoring unit for restoring the decoded second image data by using the information of the second image data;
a regenerating unit for synthesizing and regenerating a 3D image by using the first image data and the restored second image data;
a display unit for displaying the synthesized and regenerated 3D image.

9. The system as claimed in claim 7, wherein the data converting unit is a subtracting unit for converting a difference between the first image data and the second image data to the second image data.

10. The system as claimed in claim 8, wherein the data restoring unit corresponds to a subtracting unit for converting a difference between the first image data and the second image data to the second image data, and is an adding unit for restoring the second image data in such a manner that a difference between the first image data and the second image data is added to the first image data.

11. The system as claimed in claim 7, wherein the data converting unit is an image reducing unit for converting a value, which is obtained by reducing the second image data with a ratio, to the second image data.

12. A system as claimed in claim 8, wherein the data restoring unit corresponds to an image reducing unit for converting a value, which is obtained by reducing the second image data with a ratio, to the second image data, and is an image enlarging unit for restoring the second image data in such a manner that the second image data is again enlarged with a ratio used in the image reducing unit.

13. The system as claimed in claim 7, where the data converting unit is a depth map generating unit for converting a depth map, which shows a difference between a distance from the first camera to the first image data and a distance from the second camera to the second image data as a numerical value, to the second image data.

14. The system as claimed in claim 8, wherein the data restoring unit corresponds to a depth map generating unit for converting a depth map, which shows a difference between a distance from a first camera to the first image data and a distance from a second camera to the second image data as a numerical value, to the second image data and is a depth map analyzing unit for restoring the second image data by using the depth map, wherein the first camera is for photographing an image of a left sight point respective to a subject so as to output the first image data and the second camera is for photographing an image of a right sight point respective to the subject so as to output the second image data.

15. A system for generating and regenerating a three-dimensional (3D) image file based on two-dimensional (2D) media standards, in which a 3D image file is generated and regenerated according to a 3D image file format consisting of an media data box (Mdat) area and a Moov box (Moov) area of a 2D image file format according to International Standardization Organization (ISO) 14496-12, and a metadata area including information regarding image data used for generating a three-dimensional image.

16. A method for generating and regenerating a three-dimensional (3D) image file based on two-dimensional (2D) image media standards, the method comprising the steps of:
photographing an image of a left sight point respective to a subject so as to output a first image data, and photographing an image of a right sight point respective to the subject so as to output a second image data;
performing a pre-process on the first image data and the second image data;
storing the pre-processed first image data and second image data;
encoding the stored first image data and stored second image data;
performing a data converting process on the encoded second image data based on the encoded first image data;
generating a three-dimensional image file consisting of a data area including the first image data and the second image data, which has undergone the data converting process, a header area including information of the first image data, and a metadata area including information of the second image data.

17. The method as claimed in claim 16, further comprising:
parsing the information of the first image data and the information of the second image data so as to extract the first image data and the second image data;
storing the extracted first image data and the extracted second image data;
decoding the stored first image data and the stored second image data;
restoring the decoded second image data by using information regarding data conversion:
synthesizing and regenerating the first image data and the restored second image data as a three-dimensional image; and
displaying the synthesized and regenerated three-dimensional image.
